(19) United States
(12) Patent Application Publication
(10) Pub. No.: US 2024/0046635 A1
(43) Pub. Date: Feb. 8, 2024

(54) Data and Algorithm Quality Checker for Scanning Systems

(71) Applicant: Rapiscan Holdings, Inc., Hawthorne, CA (US)

(72) Inventor: Denis Dujmic, Arlington, MA (US)

(21) Appl. No.: 18/221,253

(22) Filed: Jul. 12, 2023

Related U.S. Application Data
(60) Provisional application No. 63/369,987, filed on Aug. 1, 2022.

(51) Int. Cl. G06V 10/98; G06T 5/00

(52) U.S. Cl. CPC G06V 10/993; G06T 5/002; G06T 2207/10116; G06T 2207/30168

(57) ABSTRACT

The present specification describes automated methods and systems for: checking and validating the quality of scan data that is presented to an operator of a security screening system and inspection algorithms that are configured to search for illicit cargo. The data quality is checked and validated independently of hardware vendor(s), scanner model, or scanning technology. Additionally, the methods of the present specification are configured to troubleshoot problems that may be detected during the quality check and validation processes, automatically generate periodic reports for management, generate alerts for technical personnel, and pass quality information to algorithms configured to search for contraband. Embodiments of the method implement a set of algorithms that are customized for each scanner type and location based on the collected scan data. Additionally, embodiments also provide methods to monitor quality of inspection algorithm results.

### CROSS-REFERENCE

The present specification relies on U.S. Patent Provisional Application No. 63/369,987, titled “Data Quality Checker for Scanning Systems”, and filed on Aug. 1, 2022, for priority.

The present specification relates to U.S. patent application Ser. No. 17/444,500, titled “Distributed Analysis X-Ray Inspection Methods and Systems”, and filed on Aug. 5, 2021, which is a continuation application of U.S. patent application Ser. No. 16/678,668, of the same title, filed on Nov. 8, 2019, and issued as U.S. Pat. No. 11,099,294 on Aug. 24, 2021 and U.S. patent application Ser. No. 16/678,721, titled “Distributed Analysis X-Ray Inspection Methods and Systems”, and filed on Nov. 8, 2019, and issued as U.S. Pat. No. 10,830,920 on Nov. 10, 2020 both of which are continuation applications of U.S. patent application Ser. No. 16/248,547, of the same title, filed on Jan. 15, 2019, and issued as U.S. Pat. No. 10,509,142 on Dec. 17, 2019, which is a continuation application of U.S. patent application Ser. No. 15/455,436, titled “X-Ray Inspection System That Integrates Manifest Data With Imaging/Detection Processing”, filed on Mar. 10, 2017, and issued as U.S. Pat. No. 10,422,919 on Sep. 24, 2019, which is a continuation application of U.S. patent application Ser. No. 14/739,329, of the same title, filed on Jun. 15, 2015, and issued as U.S. Pat. No. 9,632,206 on Apr. 25, 2017, which is a continuation application of U.S. patent application Ser. No. 13/606,442, of the same title, filed on Sep. 7, 2012, and issued as U.S. Pat. No. 9,111,331 on Aug. 18, 2015, which, in turn, relies on U.S. Patent Provisional Application No. 61/532,093, titled “X-Ray Inspection System with Integration of Manifest Data with Imaging/Detection Algorithms” and filed on Sep. 7, 2011.

The present specification also relates to U.S. patent application Ser. No. 16/926,453, titled “Systems and Methods for Detecting Threats and Contraband in Cargo” and filed on Jul. 10, 2020 and issued as U.S. Pat. No. 11,287,391 on Mar. 29, 2022, which is a continuation of U.S. patent application Ser. No. 16/376,971, of the same title, filed on Apr. 5, 2019 and issued as U.S. Pat. No. 10,768,338 on Sep. 8, 2020, which is a continuation application of U.S. patent application Ser. No. 15/431,011, of the same title, filed on Feb. 13, 2017, and issued as U.S. Pat. No. 10,302,807 on May 28, 2019, which, in turn, relies on U.S. Patent Provisional Application No. 62/298,383, entitled “Tanker Content Assessment” and filed on Feb. 22, 2016.

The above-referenced applications are incorporated herein by reference in their entirety.

### FIELD

The present specification relates to performing security inspection operations, and more particularly relates to systems and methods for performing security inspection operations by performing a quality check on the security data and by uniformly validating the quality of the security data for security inspection systems regardless of the proprietary format of the given security inspection system.

### BACKGROUND

The globalization of trade has opened international boundaries for the exchange of goods but has also paved the way for the illegal transportation of contraband such as explosives, narcotics, counterfeit goods, undisclosed currency, chemical, and nuclear weapons. To determine the legitimacy and applicable import laws for a given shipment of cargo, cargo containers are typically associated with a corresponding manifest document, which is an electronic or physical document having descriptive information about the cargo containers such as bills, the shipment consigner, consignee, cargo description, amount, value, origin, and/or destination. The manifest enables individuals at import or export checkpoints to determine whether transporting cargo is permitted and, if so, what duties, costs, or fees may be associated therewith.

At transportation centers, such as ports or airports, the cargo must be inspected, often physically, to determine if the cargo contents correspond with the manifest. More frequently, this inspection is being done using radiation-based systems which enable the rapid imaging of cargo contents without the delays typically caused by physical inspection. However, security systems at the transportation centers are limited in their ability to accurately detect contraband or other dangerous objects, which are often well hidden in the cargo containers. In particular, the detection of the contraband is difficult since corresponding images are superimposed, confounding permitted cargo with the contraband, thereby resulting in an interpretation of threat levels associated with the corresponding images difficult to determine. Further, an operator, at all times, must analyze the images to detect the level of threat associated with the corresponding objects in the images, thus, making it prone to human errors and adding excessive time into the process. Therefore, automated systems, to the extent they can be accurate in determining whether the cargo contents match a manifest and/or contain contraband, would be preferred over manual inspection operations.

U.S. Pat. Nos. 9,111,331B2 and 10,509,142B2, both assigned to the Applicant of the present specification, disclose X-ray inspection systems that integrate manifest data for cargo and light vehicles with the X-ray images generated during scanning. Further, the X-ray inspection systems disclosed in U.S. Pat. Nos. 9,111,331B2 and 10,509,142B2 describe that the cargo may be withheld for further inspection, in case of a mis-match between cargo contents shown by manifest data and the X-ray images generated during scanning. U.S. Pat. Nos. 9,111,331B2 and 10,509,142B2 are herein incorporated by reference in their entirety.

However, despite the success and improvements to the speed and accuracy of inspection systems using the aforementioned inventions, there is still a need for improvements to the security inspection process. Customs and security inspections need reliable and consistent data from scanning hardware and processing algorithms. The acquired data varies greatly based on scanner model or scanning technology. Inspection officers that review scan data and make decisions are trained to recognize threats in good-quality data but are not necessarily experts in scanner design and algorithms configured for data preparation. Their focus is to carry out the inspection even if the data quality is degraded. Scanner data, however, may have transient problems and slow quality degradation, which are likely to stay unreported for a long time, therefore affecting the mission without the knowledge of the inspection management or the hardware vendors. As a result of potential data quality (e.g. x-ray image degradation), inspection officers may incorrectly adjudicate scans. Automated inspection algorithms are also affected by degradation of data quality and even small deficiencies can change the algorithm result. In particular, false negative results (including letting an illicit item through) due to data quality issues are unlikely to get noticed. In rare cases, hardware vendors monitor the health of their systems and alert operators in case of problems. Systems that achieve high operation time without errors are expensive to develop and require cooperation from each hardware vendor. In addition, business pressures to achieve high operation time without errors may result in under-reporting of problems.

Thus, there is a need for an improved system that enforces a quality check on the scanner data independently of the hardware vendor, scanner model, scanning technology, or scanner data format or whether the vendor provides system health information. There is also a need to verify scan data quality prior to both human and algorithmic inspection.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

### SUMMARY

The following embodiments and aspects thereof are described and illustrated in conjunction with systems, tools and methods, which are meant to be exemplary and illustrative, and not limiting in scope. The present application discloses numerous embodiments.

In some embodiments, the present specification discloses a method for performing a quality and integrity check of data received from two or more non-intrusive inspection systems, each of which is adapted to scan objects, comprising: receiving first data in a first format from a first of the two or more non-intrusive inspection systems and receiving second data in a second format from a second of the two or more non-intrusive inspection systems, wherein the first format is different from the second format and wherein the first of the two or more non-intrusive inspection systems is a same type of non-intrusive inspection system as the second of the two or more non-intrusive inspection systems; extracting a plurality of variables from the first data and the second data; processing the plurality of variables to determine at least one of a verification of a quality of scans associated with the first data or the second data or whether a quality of the first data or the second data is declining; and generating data representative of a graphical user interface adapted to present information indicative of the quality or integrity of the first data and second data.

Optionally, the plurality of variables comprise data indicative of a scanner type, data indicative of an algorithm type, and/or data indicative of an order.

Optionally, the first data and the second data comprise a unique scan identifier associated with each scan image. Optionally, the first data and the second data comprise data indicative of a type of scan.

Optionally, determining the verification of the quality of scans comprises at least one of determining a status of hardware associated with the first of the two or more non-intrusive inspection systems or the second of the two or more non-intrusive inspection systems, evaluating scan data quality, comparing first data or second data against shipping documentation, or determining a quality of metadata associated with the first data or second data.

Optionally, determining whether the quality of data is declining comprises at least one of predicting failure, analysis of feedback provided by operators of the two or more non-intrusive inspection systems, or monitoring trends associated with each of the two or more non-intrusive inspection systems.

Optionally, the method further comprises processing the plurality of variables to determine data indicative of image enhancement filters, fusion of different data sources, denoising, or improving imaging results.

In some embodiments, the present specification discloses a computer readable non-transitory medium comprising a plurality of executable programmatic instructions wherein, when said plurality of executable programmatic instructions are executed by a processor, a process for performing a quality and integrity check of data received from two or more non-intrusive inspection systems, each of which is adapted to scan objects, said plurality of executable programmatic instructions comprising: programmatic instructions, stored in said computer readable non-transitory medium, for receiving first data in a first format from a first of the two or more non-intrusive inspection systems and receiving second data in a second format from a second of the two or more non-intrusive inspection systems, wherein the first format is different from the second format and wherein the first of the two or more non-intrusive inspection systems is a same type of non-intrusive inspection system as the second of the two or more non-intrusive inspection systems; programmatic instructions, stored in said computer readable non-transitory medium, for extracting a plurality of variables from the first data and the second data; programmatic instructions, stored in said computer readable non-transitory medium, for processing the plurality of variables to determine at least one of a verification of a quality of scans associated with the first data or the second data or whether a quality of the first data or the second data is declining; and programmatic instructions, stored in said computer readable non-transitory medium, for generating data representative of a graphical user interface adapted to present information indicative of the quality or integrity of the first data and second data.

Optionally, the plurality of variables comprise data indicative of a scanner type, data indicative of an algorithm type, and/or data indicative of an order.

Optionally, the first data and the second data comprise a unique scan identifier associated with each scan image. Optionally, the first data and the second data comprise data indicative of a type of scan.

Optionally, the programmatic instructions for determining the verification of the quality of scans comprises at least one of determining a status of hardware associated with the first of the two or more non-intrusive inspection systems or the second of the two or more non-intrusive inspection systems, evaluating scan data quality, comparing first data or second data against shipping documentation, or determining a quality of metadata associated with the first data or second data.

Optionally, the programmatic instructions for determining whether the quality of data is declining comprises at least one of predicting failure, analysis of feedback provided by operators of the two or more non-intrusive inspection systems, or monitoring trends associated with each of the two or more non-intrusive inspection systems.

In some embodiments, the present specification discloses a system for performing a quality and integrity check of data received from two or more non-intrusive inspection systems, each of which is adapted to scan objects, the system comprising: a processor configured to: receive first data in a first format from a first of the two or more non-intrusive inspection systems and receive second data in a second format from a second of the two or more non-intrusive inspection systems, wherein the first format is different from the second format and wherein the first of the two or more non-intrusive inspection systems is a same type of non-intrusive inspection system as the second of the two or more non-intrusive inspection systems; extract a plurality of variables from the first data and the second data; process the plurality of variables to determine at least one of a verification of a quality of scans associated with the first data or the second data or whether a quality of the first data or the second data is declining; and generate data representative of a graphical user interface adapted to present information indicative of the quality or integrity of the first data and second data.

Optionally, the plurality of variables comprise data indicative of a scanner type, data indicative of an algorithm type, and/or data indicative of an order.

Optionally, the first data and the second data comprise a unique scan identifier associated with each scan image. Optionally, the first data and the second data comprise data indicative of a type of scan.

Optionally, the processor configured to determine the verification of the quality of scans comprises at least one of determining a status of hardware associated with the first of the two or more non-intrusive inspection systems or the second of the two or more non-intrusive inspection systems, evaluating scan data quality, comparing first data or second data against shipping documentation, or determining a quality of metadata associated with the first data or second data.

Optionally, the processor configured to determine whether the quality of data is declining comprises at least one of predicting failure, analysis of feedback provided by operators of the two or more non-intrusive inspection systems, or monitoring trends associated with each of the two or more non-intrusive inspection systems.

In some embodiments, the present specification discloses a method for inspecting cargo and vehicles, comprising: scanning a cargo container or a vehicle at a service post using an X-ray imaging system; importing scan images and data associated with the scan of the cargo or vehicle; and analyzing said scan images and associated data to determine quality of the scan.

Optionally, the analyzing comprises performing a series of checks using the data associated with the scan and the scan images.

Optionally, the method further comprises verifying integrity of the data associated with the scan and the scan images.

Optionally, the method further comprises checking the data associated with the scan and the scan images to identify one or more problems with the X-ray imaging system.

Optionally, the method further comprises validating processing of the data associated with the scan and the scan images.

Optionally, the method further comprises checking the data associated with the scan and the scan images for quality of scanning process executed by the X-ray imaging system.

Optionally, the method further comprises verifying the existence of interference with other imaging systems.

Optionally, the method further comprises analyzing a plurality of data associated with the scan and the scan images to detect data quality trends. Optionally, the method comprises using the detected data quality trends to improve the method for inspecting. Optionally, the method comprises providing the detected data quality trends to at least one inspection operator, using a graphical user interface. Optionally, the method comprises providing the detected data quality trends to at least one maintenance personnel.

Optionally, the method further comprises benchmarking quality of one or more algorithms used for the inspecting of cargo and vehicles, the benchmarking comprising correlating outputs of two or more of the algorithms used for the inspecting. Optionally, the method comprises detecting changes in the correlated outputs using a convolution matrix.

Optionally, the method further comprises benchmarking quality of one or more inspection algorithms used for the inspecting of cargo and vehicles, the benchmarking comprising analyzing a sample of data associated the one or more inspection algorithms and detecting changes in one or more parameters within the sample.

Optionally, the method further comprises automatically generating at least one report of results of the analyzing.

Optionally, the method is customized for the X-ray imaging system.

The aforementioned and other embodiments of the present specification shall be described in greater depth in the drawings and detailed description provided below.

### BRIEF DESCRIPTION OF THE DRAWINGS

The accompanying drawings illustrate various embodiments of systems, methods, and embodiments of various other aspects of the disclosure. Any person with ordinary skills in the art will appreciate that the illustrated element boundaries (e.g. boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1A is a block diagram showing an exemplary system architecture, according to an embodiment of the present specification;

FIG. 1B is a flow diagram showing an exemplary set of steps performed by the components of the system of FIG. 1A, in accordance with some embodiments of the present specification;

FIG. 2A is a system schematic showing a system that includes an implementation of the application, in accordance with some embodiments of the present specification;

FIG. 2B is an exemplary schematic of algorithms implemented within the software application, in accordance with some embodiments of the present specification;

FIG. 2C illustrates a graph showing different values of TPR/TNR for identifying different cargo classes;

FIG. 2D illustrates an example of a nominal correlation matrix and a correlation matrix with deviation, using embodiments of the present specification;

FIG. 3A is a scatter plot illustrating an example of yield and variation in yield;

FIG. 3B is an image showing pixels with consistently high or low yield;

FIG. 3C illustrates the impact of bad detector pixels on a scan image;

FIG. 3D is an image showing a large group of pixels with inconsistent yields;

FIG. 3E is an example of an image generated using embodiments of the present specification showing detected noise;

FIG. 3F is an exemplary image that is used by an algorithm of the present specification to identify scan lines that have significantly lower or higher yields than the neighboring lines such as missing linac pulses;

FIG. 3G represents an exemplary image that is generated using embodiments of the present specification showing a large number of zero yield pixels;

FIG. 3H is a first exemplary image showing skewed colors;

FIG. 3I is a second exemplary image showing skewed colors;

FIG. 3J is a another exemplary image showing skewed pseudo-colors that represent atomic numbers;

FIG. 3K illustrates various exemplary images that are detected with erroneous contrast due to calibration issues;

FIG. 3L illustrates various exemplary images that are used to identify problems with the scanning;

FIG. 3M are representative schematics that show interference/crosstalk between two X-ray inspection systems where X-ray pulses from a neighboring system appear in X-ray images under inspection;

FIG. 3N illustrates an exemplary graphical representation of crosstalk pulses in an image, and is a zoomed representation of FIG. 3M;

FIG. 3O illustrates an exemplary graph of pixels versus yields analyzed by the RNN model to identify a peak, which indicates presence of crosstalk;

FIG. 4A illustrates an example of a display shown by a GUI to announce results of a check on data conversion, in accordance with some embodiments of the present specification; and

FIG. 4B illustrates another example of a display shown by the GUI to announce results of a check on crosstalk, in accordance with some embodiments of the present specification.

### DETAILED DESCRIPTION

The present specification discloses a method for checking and validating the quality of security data that is presented to an operator of a scanning system. The data quality is checked and validated independently of hardware vendor(s), scanner model, or scanning technology. Additionally, the methods of the present specification are designed to troubleshoot the problems that may be detected during the quality check and validation, automatically generate periodic reports for the management, and generate alerts for technical personnel. Embodiments of the method run a set of algorithms that are configured and/or customized for each scanner type and location based on the collected scan data.

The present specification is directed towards multiple embodiments. The following disclosure is provided in order to enable a person having ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

In the description and claims of the application, each of the words “comprise”, “include”, “have”, “contain”, and forms thereof, are not necessarily limited to members in a list with which the words may be associated. Thus, they are intended to be equivalent in meaning and be open-ended in that an item or items following any one of these words is not meant to be an exhaustive listing of such item or items, or meant to be limited to only the listed item or items. It should be noted herein that any feature or component described in association with a specific embodiment may be used and implemented with any other embodiment unless clearly indicated otherwise.

It must also be noted that as used herein and in the appended claims, the singular forms “a,” “an,” and “the” include plural references unless the context dictates otherwise. Although any systems and methods similar or equivalent to those described herein can be used in the practice or testing of embodiments of the present disclosure, the preferred, systems and methods are now described.

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

Some embodiments of the present specification are implemented as a part of a system that is configured to automatically present manifest information when a cargo container or a light vehicle is being inspected using non-intrusive X-ray imaging techniques. Details of the architectural embodiments of such a system are described and referenced herein in U.S. Pat. Nos. 9,111,331; 9,632,206; 10,422,919; 10,509,142; 10,830,920; and 11,099,294 and in co-pending U.S. patent application Ser. No. 17,444,500, all assigned to the Applicant of the present specification, all of which relate to the present specification and all of which are herein incorporated by reference in their entirety. The present specification also incorporates by reference in its entirety, the X-ray inspection systems disclosed in U.S. Patent Provisional Application Nos. 63/221,150 and 63/268,731, which describe embodiments for enabling an operator to manually or automatically compare a cargo to the corresponding manifest to determine if there is a sufficient correlation. If so, the cargo may be authorized to proceed. If not, the cargo may be sequestered for further inspection. Embodiments of the present specification can be integrated with the architecture of the referenced application.

In embodiments, “data quality” analysis refers to a series of quantitative checks that yield one or more numeric values. If the resulting values fall outside a pre-configured range of values, then the quality is determined to be unsatisfactory and can be marked as ‘fail’. The configuration of the quantitative checks is specific to each scanner type.

In embodiments, “cargo class” refers to the HTS Customs Code as defined within Harmonized Tariff Schedule of the United States (“HTS”), which sets out the tariff rates and statistical categories for all merchandise imported into the Unites States. The HTS is based on the international Harmonized System, which is the global system of nomenclature application to most world trade in goods. The standardized cargo descriptions can be found at https://hts.usitc.gov/.

Exemplary System Architecture

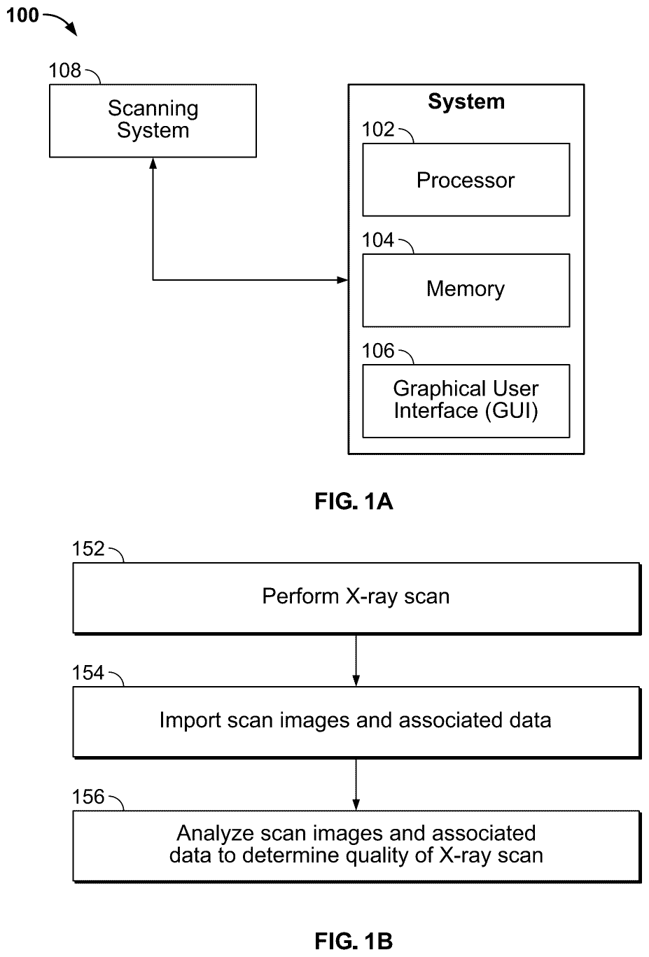

FIG. 1A is a block diagram illustrating an exemplary system 100 architecture, according to an embodiment. The system 100 may include a processor 102, a memory 104, and a Graphical User Interface (GUI) 106. System 100 is configured to be in communication with a non-intrusive inspection or scanning system 108, which may include an X-ray radiation and detection arrangement to scan target objects including vehicles and cargo to detect potential threats.

In one embodiment, the system 100 may be part of inspection system 108. One of ordinary skill in the art would appreciate that the features described in the present application can operate on any computing platform including, but not limited to: a laptop or tablet computer; personal computer; personal data assistant; cell phone; server; embedded processor; DSP chip or specialized imaging device capable of executing programmatic instructions or code.

It should further be appreciated that the platform provides the functions described in the present application by executing a plurality of programmatic instructions, which are stored in one or more non-volatile memories, using one or more processors and presents and/or receives data through transceivers in data communication with one or more wired or wireless networks.

It should further be appreciated that each computing platform has wireless and wired receivers and transmitters capable of sending and transmitting data, at least one processor capable of processing programmatic instructions, memory capable of storing programmatic instructions, and software comprised of a plurality of programmatic instructions for performing the processes described herein. Additionally, the programmatic code can be compiled (either pre-compiled or compiled “just-in-time”) into a single application executing on a single computer, or distributed among several different computers operating locally or remotely to each other.

The processor 102 includes suitable logic, circuitry, and/or interfaces that are configured to operate and to execute instructions stored in the memory to perform various functions. The processor 102 is configured to execute an algorithm stored in the memory for performing image inspection using third party artificial intelligence platforms. The processor 102 may also be configured to decode and execute any instructions received from one or more other electronic devices or server(s). The processor 102 may include one or more general-purpose processors (e.g., INTEL® or Advanced Micro Devices® (AMD) microprocessors) and/or one or more special-purpose processors (e.g., digital signal processors or Xilinx® System On Chip (SOC) Field Programmable Gate Array (FPGA) processor). The processor 102 may be further configured to execute one or more computer-readable program instructions, such as program instructions to carry out any of the functions described in the description.

Further, the processor 102 may be configured to make decisions or determinations; generate frames, packets or messages for transmission; decode received frames or messages for further processing; and other tasks or functions described herein. The processor 102, which may be a baseband processor, for example, may be configured to generate messages, packets, frames or other signals for transmission via wireless transceivers. It should be noted that the processor 102 may be configured to control the transmission of signals or messages over a wireless network, and may be configured to control the reception of signals or messages via a wireless network (e.g., after being down-converted by a wireless transceiver, for example). The processor 102 may be (or may include), for example, hardware, programmable logic, a programmable processor that is configured to execute software or firmware, and/or any combination of these. Further, using other terminology, the processor 102 along with the transceiver may be considered as a wireless transmitter/receiver system, for example.

The memory 104 is configured to store a set of instructions and data. Further, the memory 104 includes one or more instructions that are executable by the processor to perform specific operations. Some of the commonly known memory implementations include, but are not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, cloud computing platforms (e.g. Microsoft Azure and Amazon Web Services, AWS), or other types of media/machine-readable medium suitable for storing electronic instructions.

Embodiments of the present disclosure may be provided as a computer program product, which may include a computer-readable medium tangibly embodying instructions thereupon, which may be used to program or configure a computer (or other electronic devices) to perform a process. The computer-readable medium may include, but is not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other types of media/machine-readable medium suitable for storing electronic instructions (e.g., computer programming code, such as software or firmware). Moreover, embodiments of the present disclosure may also be downloaded as one or more computer program products, wherein the program may be transferred from a remote computer to a requesting computer by way of data signals embodied in a carrier wave or other propagation medium via a communication link (e.g., a modem or network connection).

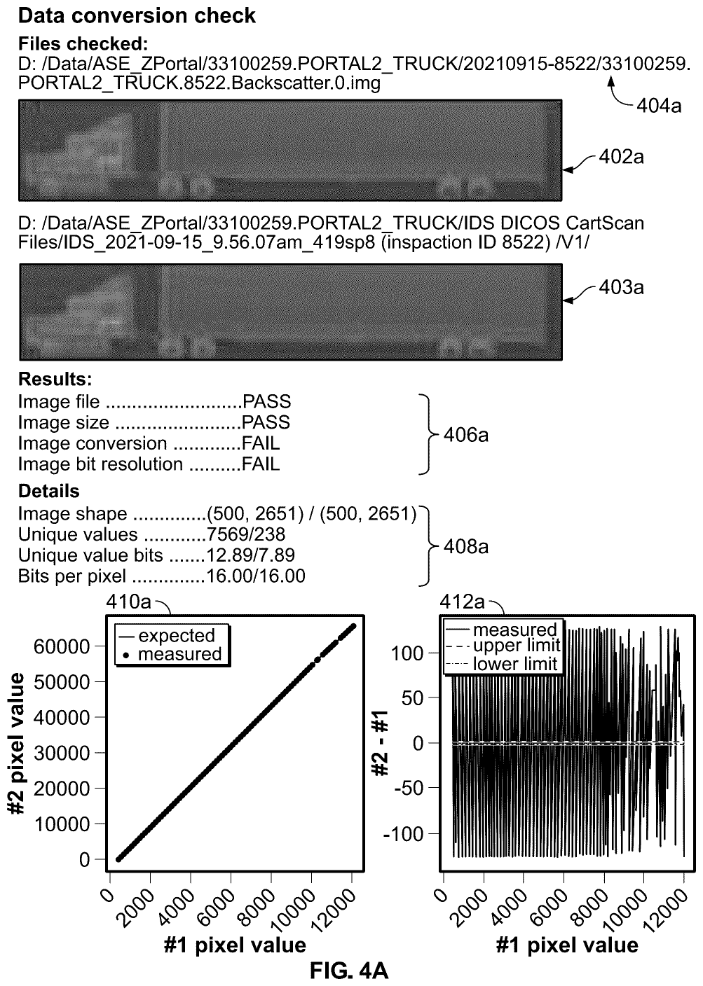

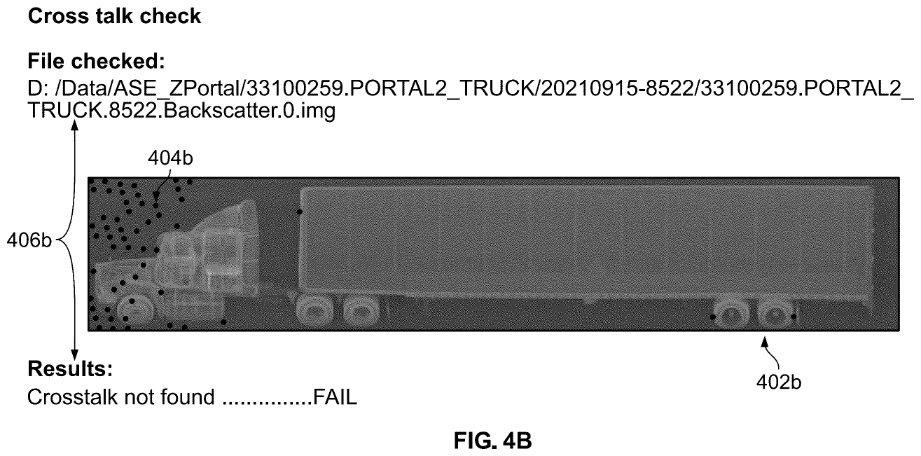

The GUI 106 may be used by an operator to view a report, notification, or an alert that is issued as a result of an analysis performed by embodiments of the present specification. FIGS. 4A and 4B illustrate a few examples of images that are displayed by GUI 106, in accordance with some embodiments of the present specification. Thereafter, an action may be performed based on the report. In one case, the report may include, but is not limited to, at least one of i) issues with data integrity, ii) problems with the hardware of the non-intrusive imaging system, iii) problems with the quality of processing of scan data, iv) trouble with timing of the scan, or v) existence of interference signals/radiation. The GUI 106 may be configured to either accept inputs from users or facilitate outputs to the users, or both. In one case, a user may interact with the interface(s) using one or more user-interactive objects and devices. The user-interactive objects and devices may comprise user input buttons, switches, knobs, levers, keys, trackballs, touchpads, cameras, microphones, motion sensors, heat sensors, inertial sensors, touch sensors, or a combination of the above. Further, the interface(s) may either be implemented as a Command Line Interface (CLI), a Graphical User Interface (GUI), a voice interface, or a web-based user-interface. In one embodiment, the GUI 106 may send notifications in a user-friendly or interactive form to the user.

It will be apparent to one skilled in the art that the above-mentioned components of the system 100 have been provided only for illustration purposes. In one embodiment, the system 100 may include an input device, output device, among others, as well, without departing from the scope of the disclosure.

System 100 is configured to receive scan data and scanner information via a second scan application (interchangeably referred to as ‘scan application’ or ‘CertScan’, wherein a first native application (and native application format) is distinguished in that it refers to data from x-ray scanners that is dependent upon the manufacturer, which is then converted to a format within the scan application or CertScan that is used to present data to the operators and algorithms) integrated with an X-ray detection system deployed at checkpoints or service posts. In one embodiment, the application works within the framework of a distributed network, wherein a service post is connected to a regional center, whereby an operator can analyze the X-ray image of the cargo in conjunction with manifest data, and data generated by system 100. When the data generated by system 100 has been analyzed, an operator at a service post is presented with a high-level summary through system 100 using GUI 106. Additionally, periodic quality checks are emailed by system 100 to relevant personnel. In the case where the analyzed data indicates significant operational problems, system 100 is configured to send instant alerts to maintenance personnel.

The scanning system or the X-ray detection system may be any suitable system for inspecting cargo, cargo containers, and their contents. As such, U.S. patent application Ser. Nos. 12/780,910; 13/370,941; 13/548,873; 13/532,862; 13/168,440; 13/175,792; 13/433,270; 13/281,622; 13/108,039; 12/675,471; 12/993,831; 12/993,832; 12/993,834; 12/997,251; 12/919,482; 12/919,483; 12/919,484; 12/919,485; 12/919,486; 12/784,630; 12/784,465; 12/834,890; 13/009,765; 13/032,593; 13/368,178; and Ser. No. 13/368,202, all assigned to the assignee of the present specification, represent various systems that may be employed with the present invention and are herein incorporated by reference in their entirety. In addition, U.S. Pat. Nos. 5,638,420; 6,542,580; 7,876,879; 7,949,101; 6,843,599; 7,483,510; 7,769,133; 7,991,113; 6,928,141; 7,517,149; 7,817,776; 7,322,745; 7,720,195; 7,995,705; 7,369,643; 7,519,148; 7,876,879; 7,876,880; 7,860,213; 7,526,064; 7,783,004; 7,963,695; 7,991,113; 8,059,781; 8,135,110, 8,170,177; 8,223,919; and 8,243,876 all assigned to the assignee of the present specification, represent various screening systems that may be employed with the present invention are herein incorporated by reference in their entirety.

FIG. 1B is an exemplary set of steps performed by the components of the system of FIG. 1A, in accordance with some embodiments of the present specification. Accordingly, at step 152, an X-ray scan is performed at scanning system 108. At step 154, the scan images and data associated with the scan is imported by system 100. As described in Applicant's previous applications, analyzed X-ray image and manifest data are sent automatically to the service post which performed the non-intrusive X-ray scan by means of data transmission from a software application (‘second scan application’ or CertScan). At step 156, the scan images and the associated data are analyzed by the application (CertScan) to determine the quality of the scan that was performed at system 108. A description of the components of the algorithm and the checks performed to determine the quality of scan are described in subsequent sections of the present specification.

In some embodiments, methods of the present specification are implemented on an algorithm server as a container on hardware. An exemplary embodiment of the hardware configuration comprises an 8 core CPU Intel i7 or better, 8 GB memory, 1 TB disk space. In another embodiment, the hardware configuration requirements include a 16 core CPU Intel i7 or better, 16 GB memory, GPU NVIDIA 3090, and 4 TB disk space. The software application is designed to present an interface to the operator at the service post, which shows the operator a rolling status of all non-intrusive X-ray scans performed at that service post, along with relevant data to allow the service post to either release the cargo or to hold it for further inspection. In one embodiment, the relevant data includes license plate number, work order number, and results of the scan. In accordance with embodiments of the present specification, system 100 is a part of software application which is also responsible for importing the scanned data and scanner information. The scan data and scanner information are used by system 100 for purposes of implementing the control process in accordance with embodiments described herein.

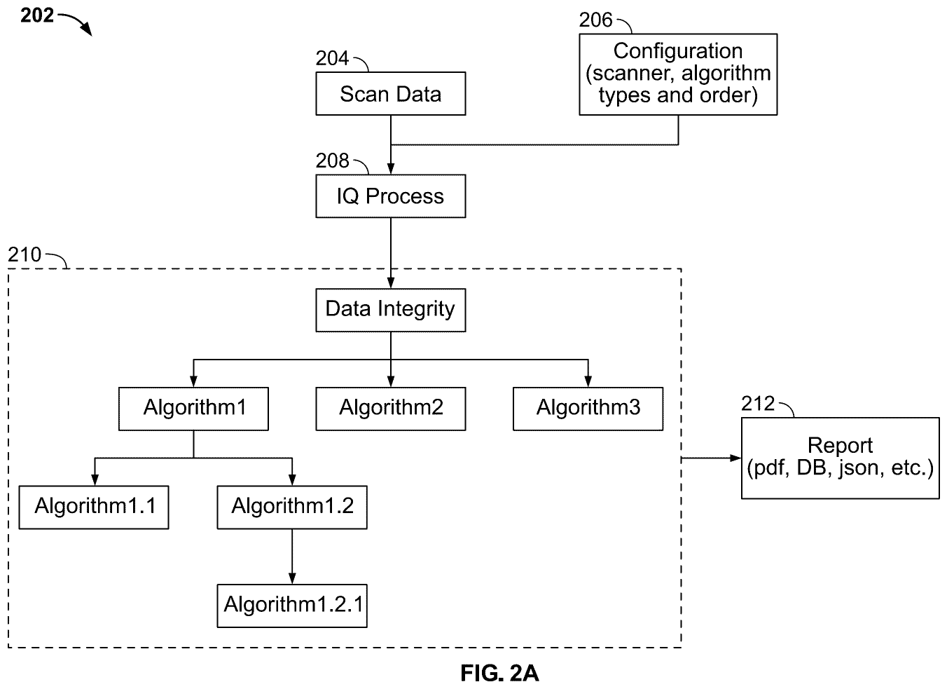

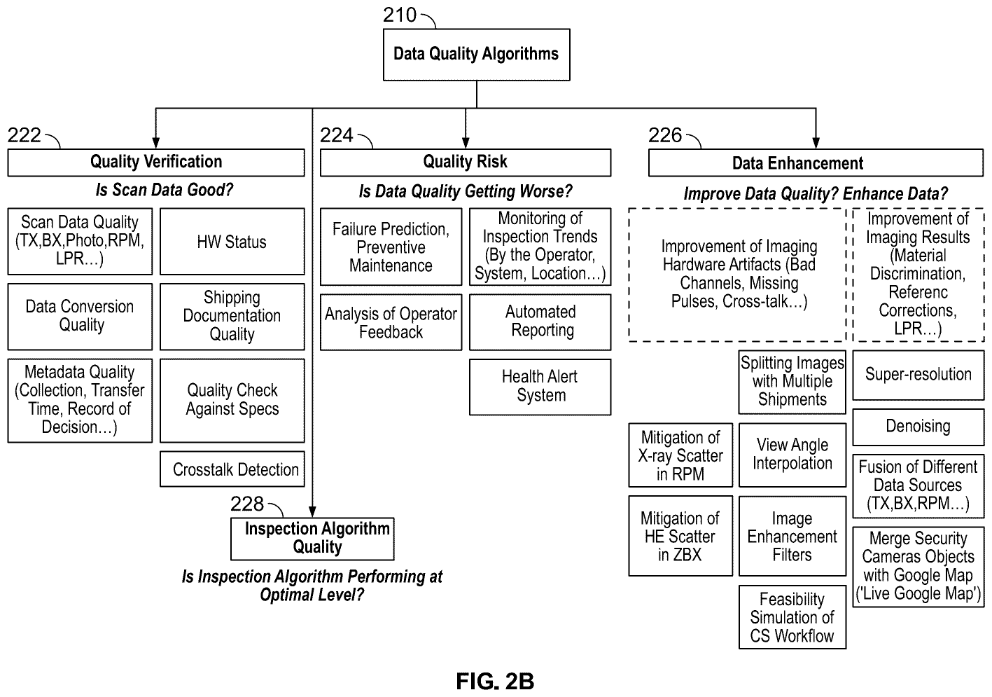

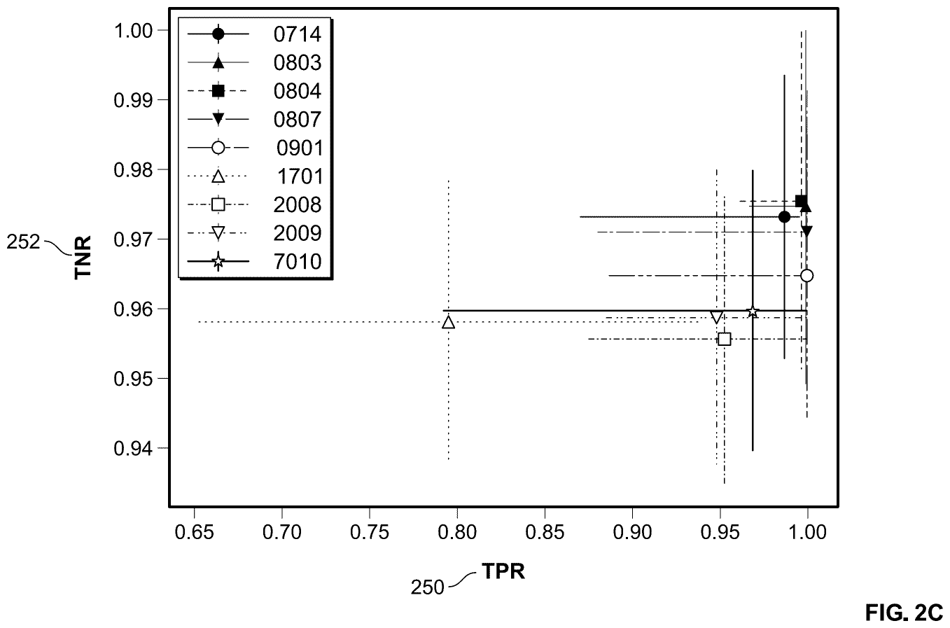

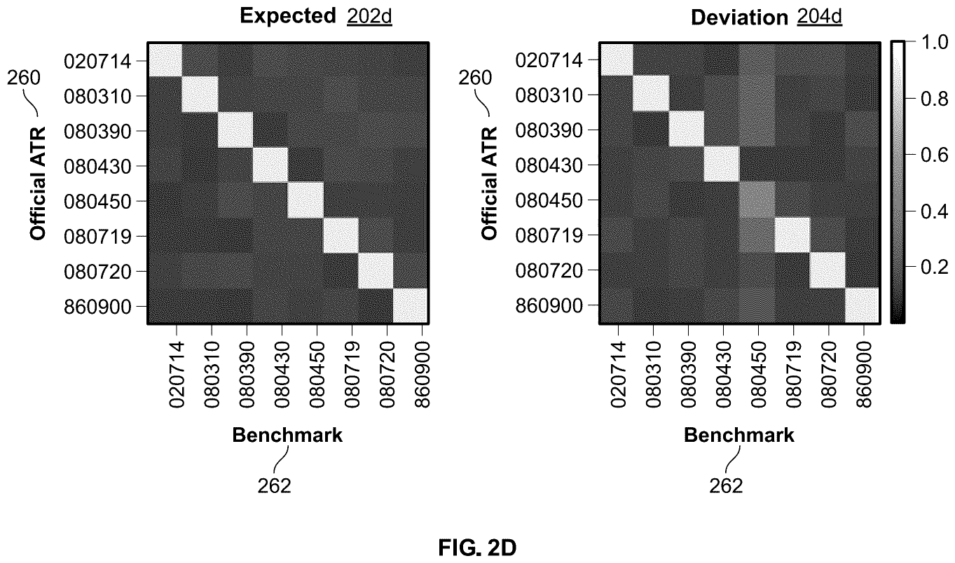

FIG. 2A is a schematic of system 100 implemented within the software application 202, in accordance with some embodiments of the present specification. A quality check and control process is initiated by the software application 202 (‘scan application’ or CertScan) by supplying a unique scan identifier, data type, and location. In an embodiment, application 202 receives scan data 204 and scanner data/information 206. Scan data 204 may include license plate number, work order number, and results of the scan such as scan image(s), identification documents, biometric data, radiation detection data, among other types of data.

Each service post may utilize one or more different scanner technologies. The various scanner technologies may encompass a combination of transmission and scatter radiation imaging systems. Scanner data/information 206 corresponds to information pertaining the scanner type from which the scan data is received. The control processes implemented by the embodiments of the present specification are customized in real time for a scanner type identified from scanner data 206, and is therefore not limited to any type of scanning hardware or software. Customization may refer to running a set of algorithms that are appropriate for the identified scanner type. In one embodiment, backscatter scanners are affected by radiation from neighboring scanners so the algorithms of system 100 are configured to check for the crosstalk only in backscatter images. In another embodiment, for transmission scanners, system 100 may be configured to check for evidence of LINAC problems. In embodiments, expected reference data values are also configured based on the identification of scanner type. Hardware Original Equipment Manufacturers (OEMs) provide images at different scales (yields for air and thick objects), therefore nominal values are preconfigured for each scanner type. Additionally, allowed deviation from expected values can be preconfigured based on the identified scanner type. In one example, a first manufacturer equipment may require air yield in a range of 59,000 to 60,000; whereas, a second manufacturer equipment may require air yield in a range of 64,000 to 65,535. In another example, the first manufacturer equipment may require variation in yield to be below 1%, and the second manufacturer equipment may require the variation to be below 2%. Embodiments of the specification may use these preconfigured values according to the manufacturer to detect problems with the imaging systems.

Referring again to FIG. 2A, system 100 is configured to implement process 208 which runs a set of algorithms 210 that are executed in a specific order and customized for each scanner type and location based on the collected data 204 and 206. A high-level summary 212 is presented to the operator through the software application 202, while periodic quality checks are emailed to relevant personnel. Some examples of a high level summary presented to the operator are illustrated in FIGS. 4A and 4B. In case of significant operational problems, the system sends instant alerts to maintenance personnel.

FIG. 2B illustrates an exemplary schematic of algorithms 210 implemented within the software application 202, in accordance with some embodiments of the present specification. Some of the algorithms are described below. In some embodiments, algorithms 210 are characterized to perform data quality checks in at least three forms: verify quality of data at 222; assess risk of the quality of data at 224; and possibly enhance data quality at 226. In some embodiments, the quality of inspection algorithms is also checked at 228. Algorithms related to quality verification 222 are configured to assess whether the received data is of an acceptable quality. Some of the checks performed under quality verification 222 are described below in the section titled ‘Intelligent Quality (IQ) Process’. Some of the key aspects that are verified under quality verification 222 include performing a check on: the image quality, data conversion quality, metadata quality, hardware status, shipping documentation quality, quality against specifications, and detection of crosstalk. In some embodiments, the cross-check may include a verification of 1) whether all shipping documents are present; 2) whether all fields in the shipping documents have been filled, 3) whether the shipping information has been cross-checked against a reference database, 4) whether declared cargo is consistent with the pattern in x-ray images and radiation data, 5) whether the sender sends uncharacteristic cargo type or receives orders of an unusual cargo type based on historic data, 6) whether sender/shipper/receiver have been caught in illicit trade in the past, 7) whether there has been an indirect trade violation relationship, for example, shipper is facilitating cargo from a receiver that often works with another sender that is a known trader of illicit goods (in this embodiment, the relationships are modeled using graph Neural Networks).

In order to assess whether the inspection algorithms used by the scanning system are performing at an optimal level, algorithms have been developed, in turn, to check the quality of the inspection algorithms 228. An optimal level, in embodiment, corresponds to the contractual levels that are agreed upon between the operator and the manufacturer of the scanning system. In one embodiment, a software upgrade of the scanning system is followed with a series of periodic checks with a fixed sample of historic scans, in order to detect problems with inspection algorithm configuration(s). If the results of the periodic checks are true positive rates (TPR) and true negative rates (TNR) that are within a contractual acceptance box that corresponds to contractually agreed and acceptable levels of a minimum TPR and a minimum TNR, it may be determined that the inspection algorithm is performing optimally. If, however, the TNR and TPR are outside an acceptable range (less than the minimum threshold values of TPR/TNR), it is determined that a problem exists with the inspection algorithm that needs to be corrected. FIG. 2C illustrates a graph showing different values of TPR 250 and TNR 252 for identifying different cargo classes. Cargo classes, as defined above, refer to the HTS Customs Code as defined within Harmonized Tariff Schedule of the United States (“HTS”), which sets out the tariff rates and statistical categories for all merchandise imported into the Unites States. The standardized cargo descriptions can be found at https://hts.usitc.gov/. The cargo class headings are typically represented by a four-digit code (such as those shown in the graph, namely, 0714, 0803, 0804, 0807, 0901, 1701, 2008, 2009, and 7010). For example, cargo class 0804 represents a cargo class that generally covers dates, figs, pineapples, avocados, guavas, mangoes and mangosteens, either fresh or dried.

An example of minimum TPR 250, TNR 252 (defining an acceptance box) are 0.7 and 0.94, respectively. Since all of the illustrated TPR 250 and TNR 252 values are within the acceptance box (greater than the minimum levels of 0.7 and 0.94 for TPR, TNR, respectively), the algorithm 228 determines that the inspection algorithm of the scanning system is performing at the contractual level. In the illustrated embodiment, both TPR 250 and TNR 252 need to be within the acceptance box defined by a range of 0.7-1.0 for TPR and a range of 0.94-1.0 for TNR in order to verify that the algorithm is performing well.

It should be noted that some of the problems with the inspection algorithm cannot be determined using the historic sample information such as that described in FIG. 2C. Therefore, in another embodiment, problems with the inspection algorithm are detected during operation of the scanning systems by comparing to benchmark official algorithms against other algorithms. Here, ‘official’ algorithm(s) refer to the actual inspection algorithms used during operation, that are expected to perform at contractual levels. The ‘official’ algorithms are purchased by the operators, for example, by the US Customs and Border Patrol, to adjudicate inspection data and/or assist an operator of the scanning device to decide upon scan data. ‘Other’ algorithms refer to the algorithm(s) run by process 208, which is configured to monitor the ‘official’ algorithm(s). Results of the ‘other’ algorithm are not visible to the operator, unlike results of the ‘official’ algorithm(s). Additionally, results of the ‘other’ algorithm(s) are not used by the operator to make any decisions. In embodiments, results of the ‘other’ algorithm(s) are correlated with the results of the ‘official’ algorithm(s). A lack of correlation and/or changes in the correlation between the results of the ‘other’ algorithm(s) and the ‘official’ algorithm(s) may be indicative of or can reflect problems with the actual inspection algorithm (or official algorithm). The absence of changes over time, or the correlation between the ‘other’ algorithm(s) and the ‘official’ algorithm(s), is indicative that the inspection algorithm is performing at an optimal level. In one exemplary implementation, an algorithm titled Empty3D, is used for verification of the official inspection algorithm implemented by a multi-view scanner and configured to check for emptiness, such as for example an empty container in a cargo. In embodiments, Empty3D is based on an analytical model, and so it has uncorrelated errors with the official algorithm which is based on a machine learning model. Therefore, at least two approaches are provided by embodiments of the present specification to verify inspection algorithms.

In addition, hardware problems within scanning devices that result in defects with the inspection, or deliberate adversarial attacks on the inspection algorithm, will have different effects on the two disclosed approaches of verifying the inspection algorithm. These problems can be detected as a deviation in the correlation matrix. FIG. 2D illustrates an example of a nominal correlation matrix and a correlation matrix with deviation, using embodiments of the present specification. Referring to FIG. 2D, a first graph 202d shows an expected correlation between the official algorithm 260 and an algorithm used to benchmark the official algorithm (benchmark algorithm 262), and a second graph 204d shows a deviation in identification of a cargo class (080450, which corresponds to mango fruit), or a lack of correlation between the official algorithm 260 and an algorithm used to benchmark the official algorithm (benchmark algorithm 262).

Algorithms related to quality risk 224 assess whether the quality of data received over a period of time is getting better or worse. Algorithms 224 can be configured to predict scanning system failure and generate alerts for preventive maintenance; monitor inspection trends based on different variables such as and not limited to operator, scanning system, and location; analyze operator feedback; generate health system alerts; and create and present automated reports. Additionally, in embodiments, a plurality of data associated with the scan and the scan images is analyzed to detect data quality trends. The detected data quality trends are used to improve the method of inspection, which includes improvement of the inspection algorithms used by the scanning devices. The inspection algorithms are verified to check whether they are performing according to contractual requirements of the scanning system, and therefore improve the output accuracy of the inspection algorithms, if required. The detected data quality trends can be provided to at least one inspection operator, using a graphical user interface in communication with the methods and systems of the embodiments of the present specification. The inspection operator can use the received verification to improve adjudication accuracy. Additionally, the data quality trends are provided to personnel for maintaining the scanning system, which can be used to improve scanning equipment reliability.

Algorithms related to data enhancement 226 are configured to actively address one or more data quality issues that may have been identified by algorithms 222 and/or quality risks determined by algorithms 224. Examples of algorithms 226 may include, and are not limited to, improvement of imaging hardware artifacts (such as for example, bad channels, missing pulses, crosstalk) by performing at least one of the following: splitting images with multiple shipments, view angle interpolation, introduce image enhancement filters, conduct feasibility simulation of CS workflow, mitigate high energy (HE) scatter in drive-through cargo and vehicle inspection systems, mitigate X-ray scatter in radiation portal monitors (RPM) Additionally, examples of algorithm 226 may include those configured to improve imaging results for better material discrimination, reference correction, improved license plate recognition (LPR), among other image-related aspects. Specifically, the algorithms are configured to achieve super-resolution of images; denoising; fuse different data sources such as TX, BX, RPM, among others; and merge security camera's object with a third party application such as Google Maps, to create live Google Map. Super-resolution refers to spatial resolution that exceeds the pixel resolution of the image (so that the image shows more details than physically possible. In an example, super-resolution may make a 1 Mega Pixel (Mpixel) image look like a 2 Mpixel image. In embodiments, super-resolution is achieved by machine learning (ML) algorithms that interpolate values between pixels using past images of high resolution as a training sample. Denoising also uses ML training based on past images with large X-ray dose to smooth out low-dose images. Data from X-ray images is fused while interpreting radiation detection data to improve detection and reduce false alarms. In an example, a cargo containing ceramic toilet bowls may create an alarm in radiation portal monitors, but it is cleared automatically by the embodiments of the present specification when it is determined that the X-ray pattern of the detected cargo is consistent with that of other ceramic toilet shipments. Further, ports are covered by cameras that can be displayed on a monitor one at the time or several views are tiled across the monitor at the same time reducing the resolution. Live map improves the situational awareness by detecting trucks and their license plates in camera views and showing their locations in the map. In this way operators can monitor traffic with one monitor.

Intelligent Quality (IQ) Process

The process implemented by algorithms 210 of FIG. 2 is designed to at least perform and/or ensure at least one or more of the following: determine data integrity; determine the performance of the scanner system (hardware); validate data processing functions; check the execution of a scan; determine the possibility of data quality degradation due to X-ray scattering from neighboring scanners (crosstalk); and improve the output accuracy of the inspection algorithms by verifying whether they are performing at contractual levels. In embodiments, the stated checks are performed sequentially by using the data and analysis from a previous check for the next step of validation. In some embodiments, the order of execution of the process enables system 100 to determine whether to perform a specific algorithm that is next in the sequence, if at all.

In an exemplary embodiment, a first algorithm checks whether all data files are converted to the scan application format (CertScan format) properly. If there is a problem with the conversion (or some files are missing) then an image quality check need not be performed in a subsequent algorithm. FIG. 4A illustrates an exemplary image of a report that is displayed to an operator though GUI 106 to announce results of a data conversion check, in accordance with some embodiments of the present specification. An image 402a that is the subject of the check is displayed along with name and location of the corresponding image file 404a. In some embodiments, image 402a is displayed in a first native format which corresponds to the data format of the scanner hardware OEM. A second image 403a is also displayed which corresponds to the second scan application (CertScan) format. In a preferred embodiment, second image 403a is displayed to the operator. Text 406a illustrates results of the check performed on the data conversion, and text 408a illustrates the image details including information such as, image shape, unique values, unique values bits, and bits per pixel. A left graph 410a plots expected pixel values based on the original image format and the CertScan value after conversion. There should be one-to-one linear relationship.

A right graph 412a shows the difference between the original and converted image pixel values that should be in the range −0.5 and +0.5. This particular example comes from a real scan that had a conversion problem.

Ensuring data integrity may refer to the process of determining whether all the scan data is collected and converted properly. The data is collected when it is received by the second scan application (CertScan) and is converted when the data format is conditioned to be compatible with the first native application executed by the systems (including algorithms and storage) used by OEM operators. The software scan application is designed to support data exchange formats that are widely accepted by Freight Management Systems (FMS) standards, web services, OCR scanning of manifest documentation, TIFF, JPG, PNG, any proprietary format, Dicos (DCS), and/or other formats including Unified File Format used by World Customs Organization and US CBP. One of ordinary skill in the art would appreciate that the system may be configured to accept additional or other forms of scan data input. Verifying data integrity may encompass verifying any of the following: whether all scan files are created; whether each file contains complete information; whether the quality of file conversion to a second scan application format from a first native application format and vice versa is correct by checking for possible degradation of bit size resolution and change in image size; and whether any information included is outdated/stale. As an example, the information is checked to determine degradation in the number of pixels (such as, 12M pixel image converted to an image of 1M pixels), or pixel bit depth (such as, pixel values rescaled from 0-65535 to 0-255). In an embodiment, the system determines possibility of an information being outdated/stale when a hardware subcomponent stops sending data so that all subsequent scans have the same data. In one example, license plate reader sends the same photo repeatedly, indicating stale data resulting from an internal hardware failure.

The algorithm can also detect metadata quality comprising aspects of data collection, transfer time, record of decision, among other types of metadata-related checks. Scan logs are a type of metadata. Typically scan logs contain various time stamps that are recorded in the logs, and that can be analyzed by the algorithm. The transfer time can be described as the difference between the recorded time stamp of the data collection by the scanning hardware and the moment the data are ready to be analyzed by the second scan application (CertScan). In embodiments, the transfer time is user-specified and varies from customer to customer. A larger value of the transfer time is directly proportional to loss of quality. In some embodiments, the preparation time is also measured by the algorithm. The preparation time may be described herein as the time required to run imaging filters and algorithms before the data is presented to the operator. Additionally, the algorithm calculates an analysis time, which is the time needed for operator to reach the decision. These are exemplary types of measurements and calculation that are performed by the algorithm of the present specification. The specification may additionally execute a combination of other evaluations that can pinpoint bottlenecks in a security inspection chain.

The data collected from each scanner is used to determine possible signs of a hardware problem associated with the corresponding scanner. Subsequently, data processing functions are validated. Yield is used as one of the parameters to determine possible signs of hardware problems. In X-ray imaging, the yield refers to the amount of radiation collected by an imaging pixel.

The pixel yield (Y) of an imaging detector can be written as,

Y=G×N+Y_{d}, where

N±√N is the number of X-rays hitting a detector module,

G±σ_{G} is the conversion factor from a deposited energy (dose) to the image pixel yield; and where σ_{G} comes mostly from the X-ray source fluctuation in output, and

Y_{d}±σ_{d} is the Analog-to-Digital Converter (ADC) bias (dark count).

The variance of the pixel yield is written in terms of the powers of the yield:

$${σ}_{Y}^{2} \approx {σ}_{d}^{2} + G \times ( Y - {Y}_{d} ) + {( \frac{{σ}_{G}}{G} )}^{2} \times {( Y - {Y}_{d} )}^{2}$$

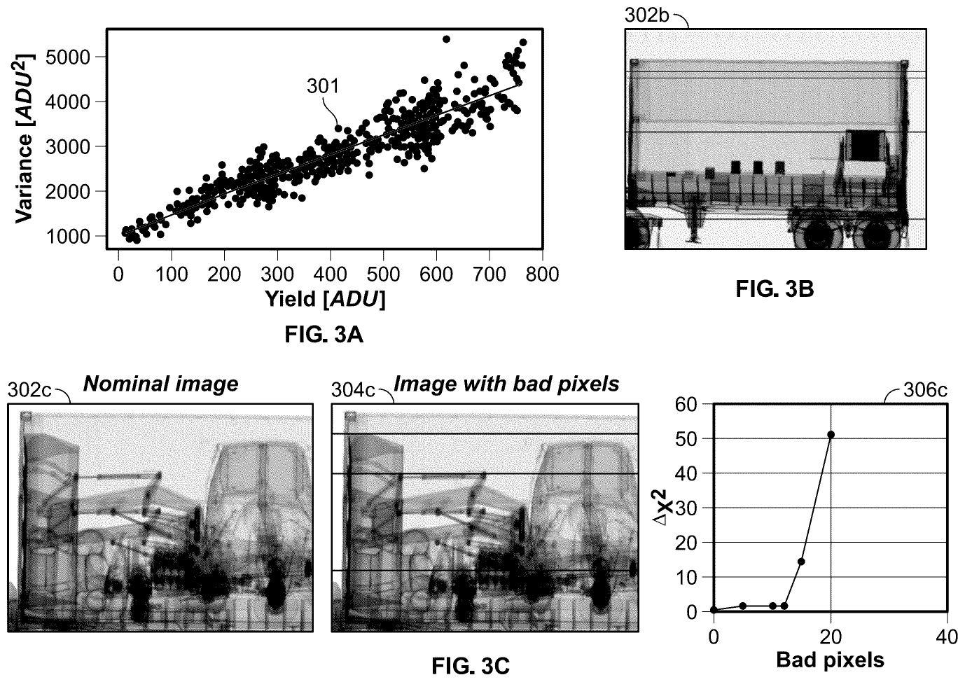

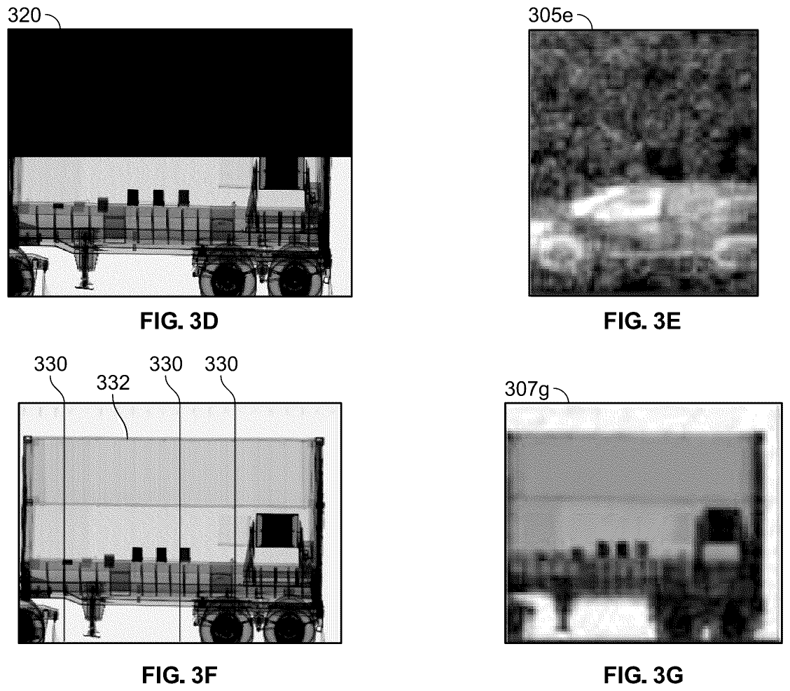

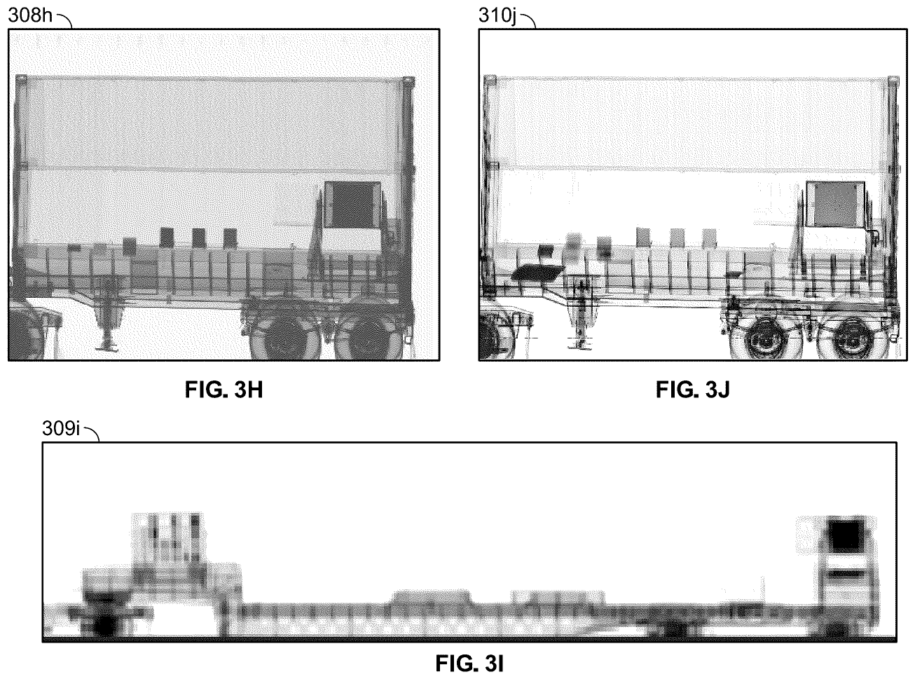

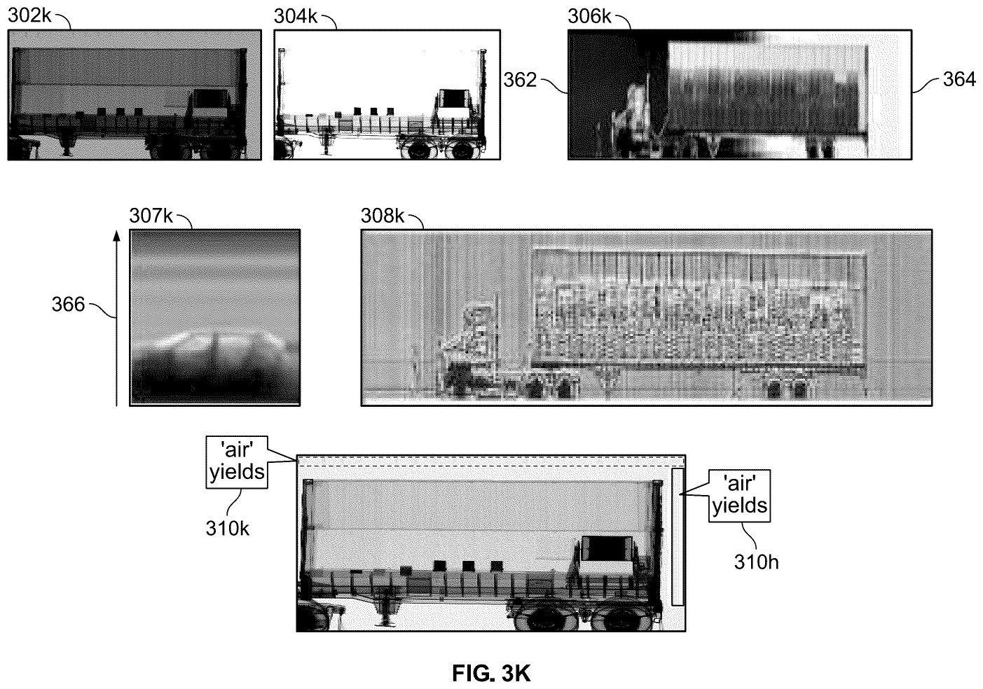

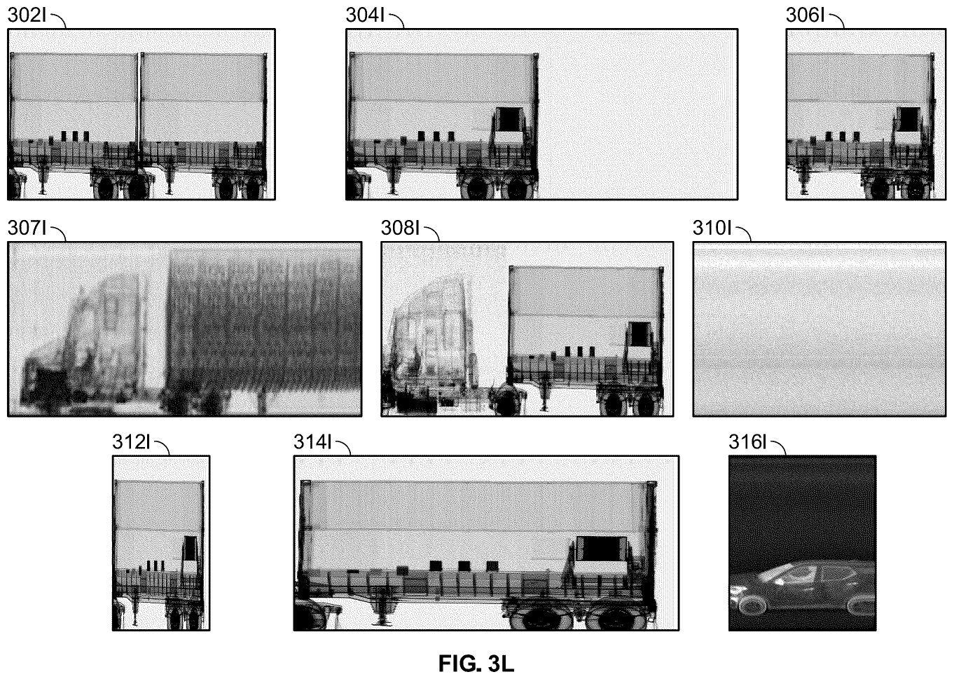

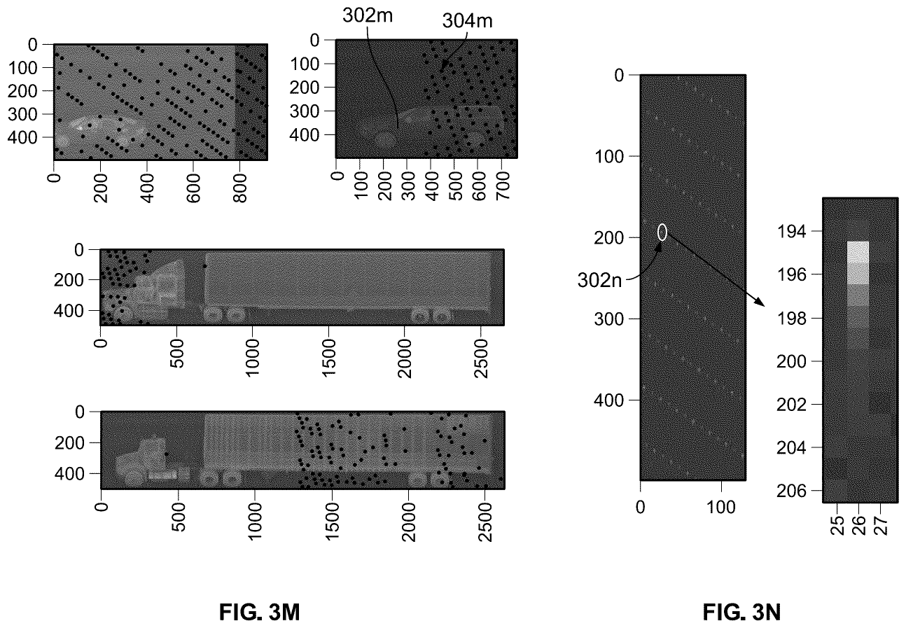

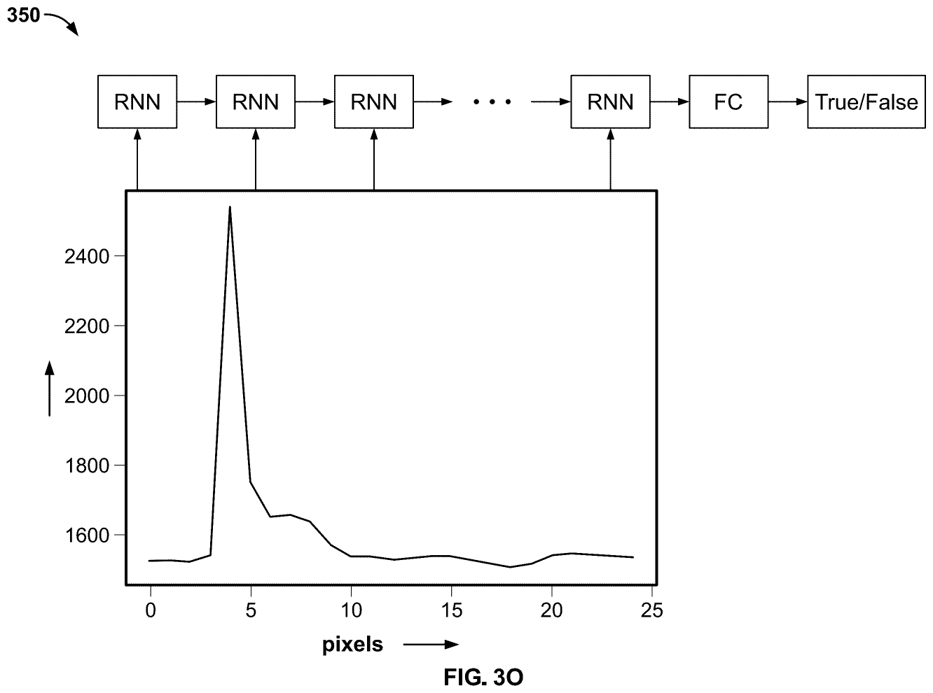

Embodiments of the scan algorithm (CertScan) measures parameters σ_{d}², G and [symbol] using observed pixel values and variation in pixel values during a scan. FIG. 3A illustrates an example of yield and variation in yield using a plot 301 that gives:

$${σ}_{d}^{2} = 400 , G = 5 , ( \frac{{σ}_{G}}{G} ) = 0.001$$

Using the given example of FIG. 3A, based on historic scans the normal ranges can be calculated as:

$${σ}_{d}^{2} = [ 350 , 525 ] , G = [ 4.8 , 5.4 ] , ( \frac{{σ}_{G}}{G} ) < 0.005$$

Specific examples of processes that check hardware problems and problems with data processing functions are described with reference to FIGS. 3B to 3K. FIG. 3B illustrates an image 302b with pixels with consistently high or low yield. Consistent high or low yield pixels appear as dark or white vertical lines that may be indicative of bad detector channels. The dark lines appear in the images a) if an average horizontal gradient of pixel values along scan lines is much smaller, for example by a factor of 100, than the vertical gradient, b) if all line pixel values are below a lower threshold (<0.01), or c) if all values are above an upper threshold (>0.99). A consistent yield refers to the yields that can be predicted. In one example, pixels unobstructed by objects should always have similar (consistent) yields. Referring again to the figure, some pixels consistently give zero (or very low) yields. Low pixel yields, in some embodiments, may occur as a result of corrosion between contacts of the scintillator photodiode readout, which is an indication of ageing of the imaging array. Low yield pixels are detected by searching for the low yield (Y) pixels even when neighboring pixels show high yield. This can be explained with the following equations:

The yield of pixel n is small, Yₙ<threshold1, where threshold1 can be 100 in an example.

Yield change along scan lines is small,

$$\frac{Δ Y}{Δ s} < threshold 2 ,$$

where threshold2 can be 10 in the same example.

Yield difference from neighboring pixels is large,

$$\frac{{Y}_{n + 1}}{{Y}_{n}} > threshold 3 and \frac{{Y}_{n - 1}}{{Y}_{n}} > threshold 3 ,$$

where threshold3 can be 1000 in the example.

FIG. 3C illustrates the impact of bad detector pixels on the resulting scan image. A nominal image 302c of a cargo was degraded through a series of numeric experiments by adding bad detector pixels, which then provided image 304c (with bad detector pixels) of the same cargo. In the experiment, image 304c is input to a conventional cargo classification algorithm configured to classify the cargo in image 304c. The algorithm result 306c is a feature vector describing the cargo class. Result 306c shows, after adding 12 or more bad detectors, the feature vector significantly deviates from the result based on nominal image 302c.

Here, the calculation is based on the following equation:

ΔX²=mean square deviation of feature vectors

FIG. 3D illustrates an image with a large group of pixels 320 with inconsistent yields or zero (low) yields. In some scanning devices, detector channels are read out in groups. If a controller for a group malfunctions, then the entire group is read out incorrectly. Typically, large groups of pixels have yields of either 0 or 1 (normal range is 0-1). The algorithm is configured to detect dark patches (where the yield is <0.01) or white patches (where the yield is >0.99) of neighboring pixels. The algorithm may detect problems such as those illustrated in area 320 of FIG. 3D by searching for groups of 5×5 pixels, in an exemplary embodiment, where such groups have a low average yield, thus appearing as a dark patch. This can be illustrated with the following equation:

An average yield of a group of 5×5 pixels (Y(5×5))<threshold4, where threshold4 can be a value of 100 in an example.

Thus, the algorithm is configured to detect the yield-related problems with pixels and associate the same with the imaging detector that is the source of the corresponding image.

In embodiments, the algorithm is configured to measure a standard deviation of air pixels representing the space in an image around an object to check if the value falls in a nominal range such as, for example, between 0.001 to 0.03. If the value falls within the nominal range, the yield is considered to be consistent. If however, the value is outside the nominal range, the image is interpreted to contain a large amount of noise. An example of a scan image 305e with noise is shown in FIG. 3E.

FIG. 3F illustrates another exemplary image that is used by the algorithm to identify scan lines that have significantly lower or higher yields than the neighboring lines, such as missing linac pulses, similar to that in FIG. 3D. Detected vertical dark lines 330 or white lines 332 appear in the generated image. Dark lines (having an average line yield <0.05) correspond to failed linac pulses, which are pulses that produce little radiation. Pulses typically produce little radiation in cases where, for example, there is sparking in the magnetron or timing mismatch between the source X-rays and the readout. White lines (having an average line yield >0.99) indicate too much radiation, which can be due to X-ray source malfunctioning. Radiation from linacs is received in pulses, but sometimes linacs fail to produce radiation (resulting in ‘missing pulses’) that results in black vertical lines in the image. The ‘missing pulses’ can also refer to X-ray pulses that occasionally have very low X-ray output. The algorithm is configured to search for vertical dark lines with low/zero yield even for unobstructed pixels. ‘Missing pulses’ are detected by the scan application algorithm (Certscan) by imposing a threshold for the average yield of the scan line. In an exemplary embodiment, the threshold for yield is set to a value of 100. The problems such as the one illustrated in FIG. 3F, once detected by the algorithm, is associated with the radiation sources used by the scanner, since the problem may result from sparking inside the RF source in some cases, or other hardware issues.

FIG. 3G represents an image 307g that is detected by the embodiments of the present specification with a large number (for example, greater than 100) of zero yield pixels corresponding to objects that cannot be penetrated by X-rays. The algorithm analyses the presence of large number of pixels of zero yield resulting from a drop in the X-ray source dose and/or energy; or too dense an object passing through an otherwise normally operating X-ray scanner.

FIGS. 3H, 3I and 3J illustrate images 308h, 309i, and 310j respectively, with skewed colors. Dual energy scanning systems may present color in generated scan images, where the colors represent atomic numbers (Z) (may \also be referred to herein as pseudocolors that represent atomic numbers): low Z is typically orange, medium Z is green, steel and similar metals are blue and high Z (lead, uranium) are purple. If the whole image is blue (R<0.1, G<0.1, B>0.95), which represents a material like steel, or in a particular shade of a color, then the colors of the image are referred to as ‘skewed’, and the material discrimination may be interpreted to be of poor quality. An example of an image that is of a particular shade of color is shown in image 308h of FIG. 3H (represented here by shading or stippling). Also, if the same object (for example, a container) is both blue and green then the algorithm is configured to recognize this as a measure of incorrectness. The generation of scan images with skewed colors enables the algorithm to interpret problems with material separation quality of detected cargo. Image 309i of FIG. 3I shows a set of calibration targets (known materials) that have wrong colors.

FIG. 3K illustrates various exemplary images 302k, 304k, 306k, 307k and 308k, that are detected with wrong contrast. The algorithm is designed to use the detection of these images to identify problems with calibration and data processing. In some cases, the algorithm detects the presence of unspecified imaging filters. In most cases, imaging filters are easy to apply, but hard to reverse. An averaging filter can make the image very smooth and remove snow-like noise, but also hide details. On the other hand, a sharpening filter can increase the noise in an image. Therefore, the algorithm can be configured to ensure that scanners provide unfiltered images so operators can apply additional (required) filters and selectively revert back to the original image.

In embodiments, problems illustrated in images 302k, 304k, 306k, 308k are detected by evaluating yields of unobstructed pixels (air′ yields) 310k either above or behind the conveyance. The nominal air yield and variance along the scan depends on the scanner manufacturer. In one example, a required air yield is in range [59,000, 60,000] for a first manufacturer and in a range [64,000, 65535] for a second manufacturer. In an embodiment, the algorithm is configured to calculate a mean value of pixels outside of the image of the object. The mean value of pixels in the image without the scanned object comprises air, and may be termed as ‘air value’. In an example, if an allowed range of air value is 0.9-0.95 on a scale of 0 to 1 for pixel yield, the air value outside the allowed range indicates that the image contrast is incorrect. In an example, an air value of 0.6 would mean that the image is too dark, such as image 302k, and an air value of 0.99 would mean that the image is too bright, such as image 304k. The algorithm also checks for variation in the yield. In the same example, a variation of below 1% is acceptable for the first manufacturer, and that of below 2% for the second manufacturer.

In embodiments, air values are expected to be constant along a scan direction (horizontal) and along an imaging array (vertical). If any part of an image is outside the normal range then the image is analyzed by the algorithm and determined to have contrast normalization problem, although the average air value might be fine. Referring to image 306k, a front portion 362 of the image is too dark (in an example, here the air value is 0.3) and a rear portion 364 of the image is too bright (in the same example, the air value in here is 0.99) since the air value varies in the horizontal direction along the scan. Referring to image 307k, the air value varies in the vertical direction 366 along the imaging array.

Additionally, air values from one scan line to another scan line should not vary outside of the expected range. In one embodiment, the algorithm is pre-configured to determine that a standard deviation of the air yields from one scan line to another scan line should be less than 0.03 (on the yield scale of 0 to 1). Thus, if the measured air value is determined to be above 0.03 then the image will have artifacts that look like column-wise noise, as shown in image 308k.

Following the validation of data processing functions, the execution of each scan is checked. FIG. 3L illustrates various exemplary images that are used to identify problems with the scanning or scan execution. Most scanning devices use a convolutional neural network (CNN)-based algorithm that is configured to detect the presence of a container (cargo portion of a vehicle or conveyance). In embodiments of the present specification, the detection of two or more containers within a scan image is used to issue a warning. Image 302l is an image that is detected with multiple shipment conveyances (containers, pallets) that may prohibit matching with the shipping documentation. If the image, such as 302l, shows two containers, and correspondingly two shipping manifest, then the algorithm indicates that only one of four conveyance-manifest pairs is correct. Image 302l is an indication of decreased accuracy of inspection. Images 304l to 310l are examples of problems with scan timing, indicating that the scan may have been started or stopped too early or too late. Problems with scan timing result in high radiation doses to bystanders or result in cut-off images. Image 304l is an example of a scan that is continued for too long. For a scan that is continued for too long, the algorithm detects the scan that shows too much in an image, such as for example the scan shows both truck cab and container, indicating that the cab was also irradiated and the driver in the cab got a high radiation dose. In an embodiment, a threshold of 100 empty scan lines is used, which when crossed, is determined to be a cause to raise an alarm. In some embodiments, the imaging system is configured to detect the front or the end of an object (conveyance or vehicle) out of time so that a part of the object is cut off in the resulting scan image. The algorithms used in the present specification are configured to detect if an image has empty lines in the front or back of an image of the object in order to verify that the scanned object is not cut off. In an exemplary embodiment, the algorithm is configured to analyze 10 lines at the front (or back) of an image of an object (vehicle or conveyance) and is further configured to determine whether at least one scan line has a pixel yield consistent with the object, where the average yield may lie in the range of 0 to 0.7.

Image 306l is an example of a scan that is started too late so that a front portion of the object is cut off. Image 307l is an example of a scan that is stopped too early so that later or end portion of the container is cut off. The algorithm is configured to determine the case of a late scan by interpreting an image that shows only a part of a target object, such as for example, a portion of a container, wherein the start of the container is cut-off from the image. Scanning devices typically include a convolutional neural network (CNN) algorithm to detect truck cabins, so that the cabin area is not irradiated and only the cargo area following the cabin area is inspected. If an image of a truck cabin is identified, then the algorithm is configured to flag the instance as a fault since it likely means that the driver was irradiated with a high dose. Image 3081 is an example of an image that is generated by a scan that is started too early and irradiates the driver of the scanned vehicle. Further, empty images are detected by embodiments of the present specification, which have less than 100 consecutive scan lines that are inconsistent with air. Image 310l is an example of a an image that is generated by a scan that is performed without an object. The algorithm interprets a scan image with multiple scan lines without objects to be a case where unnecessary radiations were output into the surroundings.

Additionally, scan-related problems that are detected based on the speed of performing the scan are identified by the algorithm. Image 312l of FIG. 3L is an example of a high-speed scan. Image 312l results when a driver drives too fast during the scan so that the scan image has too few scan lines resulting in a small spatial resolution. Image 314l is an example of a low-speed scan. Image 314l results when the driver drives too slow so that the resulting scan image has too many scan lines. A low-speed scan additionally results in a higher X-ray dose to the object and into the environment. Also, image 316l is of a scan where the target object (in this case, a car) has stopped in the radiation beam of the scanner. Nominal imaging parameters, such as and not limited to—the mean value and standard deviation—of unobstructed pixels, detection of too low or high pixel yields, among other image parameters, are determined by the algorithm from a sample of historic scans that were identified to be without any problems (good scans), and are compared with the values from a current scan. All of the above-mentioned images are detected and used by the algorithm to interpret scan-related problems with the corresponding scanner.

Finally, algorithm 210 includes a process to determine the possibility of data quality degradation due to crosstalk with neighboring scanners. X-ray pulses scattered from nearby imaging systems into the imaging systems that use X-ray tubes (such as and not limited to backscatter scanners and vehicle scanners) are detected as crosstalk. In embodiments, any X-ray pulses scattered from a neighboring imaging system and intercepted by another imaging system is referred to as crosstalk. High energy (greater than 1 MeV) scanners create pulsed radiation that is recorded as a series of pixels with high yields in backscatter images. FIG. 3M illustrates multiple examples of crosstalk detection in scan images of a car and a truck. An image of a vehicle 302m is shown that is overlapped by an image of scattered X-ray particles 304m from a neighboring scanning system. FIG. 3N illustrates an exemplary graphical representation of crosstalk pulses 302n in an image and is a zoomed representation of FIG. 3M. Presence of crosstalk pulses can confuse the operator and lead to lower inspection performance. It should be noted that in FIGS. 3M and 3N, the x-axis represents the width of the image while the y-axis represents the height of the image.

In embodiments, a recursive neural network (RNN) is used to model the yield of crosstalk pulses as a function of time. Examples of RNN used include, and are not limited to, GRU, LSTM, among other types of RNN. The neural model is trained on historic examples of images with and without crosstalk. The RNN model analyzes stream of a group of pixels to search for evidence of peaks. In an example, a group includes 25 pixels. FIG. 3O illustrates an exemplary graph 350 of pixel indexes versus yields analyzed by the RNN model to identify a peak, which indicates presence of crosstalk. The crosstalk pulses, which include scatter from neighboring X-ray systems, is detected if the number of crosstalk candidates exceed the threshold. In one exemplary embodiment, the threshold is 10 crosstalk candidates per image. In embodiments, the crosstalk candidate status is based on a probability estimated by the neural net.

FIG. 4B illustrates an exemplary result of a crosstalk check performed by the algorithm, in accordance with some embodiments of the present specification. The generated scan image 402b of a truck is shown with crosstalk candidates 404b concentrated towards a front portion of image 402b of the truck. Text 406b shows the name and location of the image file that is checked and results of the check, which in this case indicates that crosstalk was found.

The above examples are merely illustrative of the many applications of the system of present specification. Although only a few embodiments of the present invention have been described herein, it should be understood that the present invention might be embodied in many other specific forms without departing from the spirit or scope of the invention. Therefore, the present examples and embodiments are to be considered as illustrative and not restrictive, and the invention may be modified within the scope of the appended claims.

What is claimed is:

1. A method for performing a quality and integrity check of data received from two or more non-intrusive inspection systems, each of which is adapted to scan objects, comprising:
receiving first data in a first format from a first of the two or more non-intrusive inspection systems and receiving second data in a second format from a second of the two or more non-intrusive inspection systems, wherein the first format is different from the second format and wherein the first of the two or more non-intrusive inspection systems is a same type of non-intrusive inspection system as the second of the two or more non-intrusive inspection systems;
extracting a plurality of variables from the first data and the second data;
processing the plurality of variables to determine at least one of a verification of a quality of scans associated with the first data or the second data or whether a quality of the first data or the second data is declining; and
generating data representative of a graphical user interface adapted to present information indicative of the quality or integrity of the first data and second data.

2. The method of claim 1, wherein the plurality of variables comprise data indicative of a scanner type, data indicative of an algorithm type, and/or data indicative of an order.

3. The method of claim 1, wherein the first data and the second data comprise a unique scan identifier associated with each scan image.

4. The method of claim 1, wherein the first data and the second data comprise data indicative of a type of scan.

5. The method of claim 1, wherein determining the verification of the quality of scans comprises at least one of determining a status of hardware associated with the first of the two or more non-intrusive inspection systems or the second of the two or more non-intrusive inspection systems, evaluating scan data quality, comparing first data or second data against shipping documentation, or determining a quality of metadata associated with the first data or second data.

6. The method of claim 1, wherein determining whether the quality of data is declining comprises at least one of predicting failure, analysis of feedback provided by operators of the two or more non-intrusive inspection systems, or monitoring trends associated with each of the two or more non-intrusive inspection systems.

7. The method of claim 1, further comprising processing the plurality of variables to determine data indicative of image enhancement filters, fusion of different data sources, denoising, or improving imaging results.

8. A computer readable non-transitory medium comprising a plurality of executable programmatic instructions wherein, when said plurality of executable programmatic instructions are executed by a processor, a process for performing a quality and integrity check of data received from two or more non-intrusive inspection systems, each of which is adapted to scan objects, said plurality of executable programmatic instructions comprising:
programmatic instructions, stored in said computer readable non-transitory medium, for receiving first data in a first format from a first of the two or more non-intrusive inspection systems and receiving second data in a second format from a second of the two or more non-intrusive inspection systems, wherein the first format is different from the second format and wherein the first of the two or more non-intrusive inspection systems is a same type of non-intrusive inspection system as the second of the two or more non-intrusive inspection systems;
programmatic instructions, stored in said computer readable non-transitory medium, for extracting a plurality of variables from the first data and the second data;
programmatic instructions, stored in said computer readable non-transitory medium, for processing the plurality of variables to determine at least one of a verification of a quality of scans associated with the first data or the second data or whether a quality of the first data or the second data is declining; and
programmatic instructions, stored in said computer readable non-transitory medium, for generating data representative of a graphical user interface adapted to present information indicative of the quality or integrity of the first data and second data.

9. The computer readable non-transitory medium of claim 8, wherein the plurality of variables comprise data indicative of a scanner type, data indicative of an algorithm type, and/or data indicative of an order.

10. The computer readable non-transitory medium of claim 8, wherein the first data and the second data comprise a unique scan identifier associated with each scan image.

11. The computer readable non-transitory medium of claim 8, wherein the first data and the second data comprise data indicative of a type of scan.

12. The computer readable non-transitory medium of claim 8, wherein the programmatic instructions for determining the verification of the quality of scans comprises at least one of determining a status of hardware associated with the first of the two or more non-intrusive inspection systems or the second of the two or more non-intrusive inspection systems, evaluating scan data quality, comparing first data or second data against shipping documentation, or determining a quality of metadata associated with the first data or second data.

13. The computer readable non-transitory medium of claim 8, wherein the programmatic instructions for determining whether the quality of data is declining comprises at least one of predicting failure, analysis of feedback provided by operators of the two or more non-intrusive inspection systems, or monitoring trends associated with each of the two or more non-intrusive inspection systems.

14. A system for performing a quality and integrity check of data received from two or more non-intrusive inspection systems, each of which is adapted to scan objects, the system comprising:
a processor configured to:
receive first data in a first format from a first of the two or more non-intrusive inspection systems and receive second data in a second format from a second of the two or more non-intrusive inspection systems, wherein the first format is different from the second format and wherein the first of the two or more non-intrusive inspection systems is a same type of non-intrusive inspection system as the second of the two or more non-intrusive inspection systems;
extract a plurality of variables from the first data and the second data;
process the plurality of variables to determine at least one of a verification of a quality of scans associated with the first data or the second data or whether a quality of the first data or the second data is declining; and
generate data representative of a graphical user interface adapted to present information indicative of the quality or integrity of the first data and second data.

15. The system of claim 14, wherein the plurality of variables comprise data indicative of a scanner type, data indicative of an algorithm type, and/or data indicative of an order.

16. The system of claim 14, wherein the first data and the second data comprise a unique scan identifier associated with each scan image.

17. The system of claim 14, wherein the first data and the second data comprise data indicative of a type of scan.

18. The system of claim 14, wherein the processor configured to determine the verification of the quality of scans comprises at least one of determining a status of hardware associated with the first of the two or more non-intrusive inspection systems or the second of the two or more non-intrusive inspection systems, evaluating scan data quality, comparing first data or second data against shipping documentation, or determining a quality of metadata associated with the first data or second data.

19. The system of claim 14, wherein the processor configured to determine whether the quality of data is declining comprises at least one of predicting failure, analysis of feedback provided by operators of the two or more non-intrusive inspection systems, or monitoring trends associated with each of the two or more non-intrusive inspection systems.

20. A method for inspecting cargo and vehicles, comprising:
scanning a cargo container or a vehicle at a service post using an X-ray imaging system;
importing scan images and data associated with the scan of the cargo or vehicle; and
analyzing said scan images and associated data to determine quality of the scan.

21. The method of claim 20, wherein the analyzing comprises performing a series of checks using the data associated with the scan and the scan images.

22. The method of claim 21 comprising verifying integrity of the data associated with the scan and the scan images.

23. The method of claim 21 comprising checking the data associated with the scan and the scan images to identify one or more problems with the X-ray imaging system.

24. The method of claim 21 comprising validating processing of the data associated with the scan and the scan images.

25. The method of claim 21 comprising checking the data associated with the scan and the scan images for quality of scanning process executed by the X-ray imaging system.

26. The method of claim 21 comprising verifying the existence of interference with other imaging systems.

27. The method of claim 21 further comprising analyzing a plurality of data associated with the scan and the scan images to detect data quality trends.

28. The method of claim 27 comprising using the detected data quality trends to improve the method for inspecting.

29. The method of claim 27 comprising providing the detected data quality trends to at least one inspection operator, using a graphical user interface.

30. The method of claim 27 comprising providing the detected data quality trends to at least one maintenance personnel.

31. The method of claim 21 further comprising benchmarking quality of one or more algorithms used for the inspecting of cargo and vehicles, the benchmarking comprising correlating outputs of two or more of the algorithms used for the inspecting.

32. The method of claim 31 comprising detecting changes in the correlated outputs using a convolution matrix.

33. The method of claim 21 further comprising benchmarking quality of one or more inspection algorithms used for the inspecting of cargo and vehicles, the benchmarking comprising analyzing a sample of data associated the one or more inspection algorithms and detecting changes in one or more parameters within the sample.

34. The method of claim 21 further comprising automatically generating at least one report of results of the analyzing.

35. The method of claim 21 wherein the method is customized for the X-ray imaging system.
